(19) United States
(12) Patent Application Publication
(10) Pub. No.: US 2002/0137652 A1
(43) Pub. Date: Sep. 26, 2002

(54) Process for preparing pouches

(76) Inventors: Gregory Martin Gressel, Cincinnati, OH (US); Mark Anthony Manion, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/990,743

(22) Filed: Nov. 14, 2001

(30) Foreign Application Priority Data
Nov. 17, 2000 (GB) 0028179.0

(51) Int. Cl. C11D 17/00

(52) U.S. Cl. 510/297; 510/296

(57) ABSTRACT

The present invention relates to a process for preparing water-soluble pouches from at least one sheet of water-soluble film, comprising the step of shaping pouches from said water-soluble film in a series of molds, wherein said molds are positioned in an interlocking manner.

### CROSS REFERENCE TO RELATED APPLICATIONS

This application claims priority under 35 U.S.C. § 119(a) to Great Britain Application Ser. No. 0028179.0, filed Nov. 17, 2000 (Attorney Docket No. CM2448F).

### TECHNICAL FIELD OF THE INVENTION

The present invention relates to a process for preparing water-soluble pouches. The process minimizes film scrap during the preparation of water-soluble pouches. The water-soluble pouches may contain a composition, especially a detergent composition.

### BACKGROUND TO THE INVENTION

Many consumers do not want to come into contact with detergent ingredients commonly used and found in detergent products, during the washing process. The laundry detergent industry has been trying to prevent or minimize the contact between detergent ingredients and the consumer. For example, the detergent industry developed detergent tablets which minimized the generation of detergent ingredients in the form of dust when handled by a consumer during the washing process. However, these detergent tablets still produce dust when handled by consumers during the washing process. Thus, there is still a need to provide a detergent product which can be used by consumers wherein the contact between the detergent ingredients therein and the consumer is prevented or further minimized.

Attempts have been made to solve this problem by enclosing the detergent ingredients with a film, to form a detergent pouch. These pouches have been further developed by the laundry industry to improve their water-solubility profile and cleaning performance.

In addition, consumers like the benefits of having unit dose detergent products, for example detergent tablets and detergent pouches. Many consumers find unit dose detergent products easier and quicker to use during the washing process. For example, by using unit dose detergent products, the amount of detergent to be used during the washing process is already pre-selected for the consumer, negating the need for the consumer to determine, and weight out, the desired amount of detergent product which can be a difficult and time consuming procedure.

The film used to make detergent pouches is typically expensive. Current processes for manufacturing detergent pouches are not very efficient and produce a large amount of film scrap. To provide detergent pouches which the consumer can afford to purchase, there is a need to develop a process for preparing these pouches which is more efficient, and produces less film scrap.

The present invention provides a process for preparing pouches which minimizes the amount of film scrap during the production of pouches. This process results in less wastage of film and provides an efficient, cost effective means of producing pouches.

### SUMMARY OF THE INVENTION

The present invention provides a process for preparing water-soluble pouches from at least one sheet of water-soluble film, comprising the step of shaping pouches from said water-soluble film in a series of molds, wherein said molds are positioned in an interlocking manner.

Preferably, the shape of said molds is a polygon. More preferably the shape of said molds is a hexagon.

The present invention also provides a water-soluble pouch, obtainable by a process comprising the step of shaping pouches from a water-soluble film in a series of molds, wherein said molds are positioned in an interlocking manner, and wherein further the shape of said molds is a hexagon.

The present invention provides a mold, or series of molds, for a water-soluble pouch, wherein the shape of said mold, is a hexagon.

The present invention provides a use of a process for preparing water-soluble pouches from at least one sheet of water-soluble film, comprising the step of shaping pouches from said water-soluble film in a series of molds, wherein said molds are positioned in an interlocking manner, to prepare water-soluble pouches.

### DETAILED DESCRIPTION OF THE INVENTION

Series of Molds

The pouches are made using a series of molds having the same shape. The molds are positioned in an interlocking manner.

The shape of the mold is the shape when viewed looking directly at the indent of the mold.

The series of molds comprise more than one mold, preferably more than two molds, or more than three molds, or more than 5 molds, or more than 7 molds, or more than 10 molds, or more than 15 molds, or more than 25 molds, or more than 50 molds, or more than 100 molds. The series of molds may comprise molds in one line or in a series of lines. For example, the series of molds may be made up by three or four lines of molds.

The molds are typically positioned in an adjacent manner. The molds are preferably evenly spaced apart.

Typically, the maximum variation in the distance between the edges of adjoining molds, is less than 200%, preferably less than 150%, or less than 100%, or less than 90%, or less than 80%, or less than 70%, or less than 60%, or less than 50%, or less than 40%, or less than 30%, or less than 20%, or less than 10%, or less than 7%, or less than 5%, or less than 3%, or less than 2%, or less than 1%, or less than 0.5%.

The molds typically comprise a straight edge or a slightly curved edge. By slightly curved edge, it is typically meant an edge having a curvature of a radius that is greater than 0.5 meters, preferably greater than 1 meter, or greater than 1.5 meters, or greater than 2 meters, or greater than 2.5 meters, or greater than 3 meters, or greater than 5 meters, or greater than 7.5 meters, or greater than 10 meters, or greater than 50 meters, or greater than 100 meters, or greater than 250 meters, or greater than 500 meters, or greater than 1000 meters. Preferably, the molds comprise at least one straight edge, more preferably the molds comprise more than one straight edge, most preferably all of the edges of the molds are straight. This allows molds having the same shape to interlock more easily, by being able to interlock via the straight edge.

Preferably the edges of adjoining molds are substantially parallel. Preferably at least one edge of a first mold is substantially parallel to at least one edge of a second mold which is positioned adjacently to said first mold, thus the variation in distance between said edges is 0%.

Leakage of ingredients from the pouch, and ruptures to the film of the pouch are more likely to occur at the corners of the pouch. The pouches prepared by the process herein, are more structurally stable and less likely to rupture or leak ingredients, if the molds comprise few corners having acute angles. Preferably, the molds comprise less than two corners having an internal angle of 90°, more preferably the molds comprise less than two corners having an internal angle of 90° or less, even more preferably the molds comprise no corners having an internal angle of 90° or less.

The mold preferably comprises at least one corner, preferably more than one corner, having an internal angle greater than 90°. The mold preferably comprises at least one corner, preferably more than one corner, having an internal angle of from 100° to 140°, most preferably having an internal angle of 120°. The mold preferably comprises corners having the same angles. The mold preferably comprises more than 4 corners, for example, the mold preferably comprises at least 5 corners, or more preferably at least 6 corners. If the corner of the pouch is rounded, then the angle of the corner is the typically the overall angle of the corner.

The shape of the mold is shape which can interlock with a mold of the same shape, to form a series of interlocking shapes. Preferably the shape of the mold is a polygon, preferably a hexagon, square, rectangle, rhombus, triangle, more preferably a hexagon. Most preferably, the mold is a hexagon, wherein the sides of said hexagon are the same size, and wherein the internal angles of the corners of said hexagon are all 120°.

The bottom of the mold is preferably rounded, the indent of the mold is preferably hemispherical-like. This is to minimize the variation of stretch introduced to a film which is pulled flush to the inner surface of the mold. The sides of the mold, which dictate the shape of the mold are preferably a series of straight edges.

The molds are typically of a size having the largest cross-sectional distance across the face of the mold being from 1 cm to 50 cm, preferably from 2 cm to 10 cm.

The mold preferably comprises an indent of a size such that the pouches obtained by the process herein have an internal volume of from 1 ml to 200 ml, preferably from 10 ml to 60 ml.

The molds preferably have a lip around the edge, which allows a source of heat or pressure to be applied around the edge of the mold during the process herein. Said lip is preferably from 0.01 mm to 10 mm, depending on the size of the mold and is preferably less than 10%, or preferably less than 9%, or less than 8%, or less than 7%, or less than 6% of the largest cross-sectional distance across the face of said mold.

Typically, if present, this lip can be raised slightly from the edge of the mold. By raising the lip, a stronger seal is formed which is less likely to leak ingredients, if present, from the pouch. This lip, if present, is typically raised from 0.001 mm to 10 mm, preferably from 0.01 mm to 0.2 mm.

The mold can be made by any appropriate material. Typically the material of the mold is capable of withstanding the amount of pressure applied to said mold during the process herein, typically this pressure is from 1×10⁴ Nm⁻² to 1×10⁶ Nm⁻². Typically the material of the mold is capable of withstanding the heat applied to said mold during the process, typically this heat is from 40° C. to 200° C.

Water-Soluble Film

The water-soluble film, herein referred to as “film”, typically the film is water-dispersible and has a dispersibility of at least 50%, preferably at least 75% or even at least 95%, as measured by the gravimetric method set out hereinafter, using a glass-filter with a maximum pore size of 50 microns.

More preferably the film is water-soluble and has a solubility of at least 50%, preferably at least 75% or even at least 95%, as measured by the gravimetric method set out hereinafter, using a glass-filter with a maximum pore size of 20 microns, namely:

Gravimetric method for determining water-solubility or water-dispersibility of the film:

50 grams±0.1 gram of film is added in a 400 ml beaker, whereof the weight has been determined, and 245 ml±1 ml of distilled water is added. This is stirred vigorously on magnetic stirrer set at 600 rpm, for 30 minutes. Then, the mixture is filtered through a folded qualitative sintered-glass filter with the pore sizes as defined above (max. 20 or 50 micron). The water is dried off from the collected filtrate by any conventional method, and the weight of the remaining polymer is determined (which is the dissolved or dispersed fraction). Then, the % solubility or dispersibility can be calculated.

The pouch is made from a water-soluble film. Preferred water-soluble films are polymeric materials, preferably polymers which are formed into a film or sheet. The material in the form of a film can for example be obtained by casting, blow-molding, extrusion or blow extrusion of the polymer material, as known in the art.

Preferred polymers, copolymers, or derivatives thereof, are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatin, natural gums such as xanthum and carragum.

More preferably the polymer is selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, most preferably polyvinyl alcohols, polyvinyl alcohol copolymers and hydroxypropyl methyl cellulose (HPMC).

The polymer can have any weight average molecular weight, preferably from about 1000 to 1,000,000, or even form 10,000 to 300,000 or even form 15,000 to 200,000 or even form 20,000 to 150,000.

Mixtures of polymers can also be used. This may in particular be beneficial to control the mechanical and/or dissolution properties of the film, depending on the application thereof and the required needs. For example, it may be preferred that a mixture of polymers is present in the film, whereby one polymer material has a higher water-solubility than another polymer material, and/or one polymer material has a higher mechanical strength than another polymer material. It may be preferred that a mixture of polymers is used, having different weight average molecular weights, for example a mixture of PVA or a copolymer thereof of a weight average molecular weight of 10,000-40,000, preferably around 20,000, and of PVA or copolymer thereof, with a weight average molecular weight of about 100,000 to 300,000, preferably around 150,000.

Also useful are polymer blend compositions, for example comprising hydrolytically degradable and water-soluble polymer blend such as polylactide and polyvinyl alcohol, achieved by the mixing of polylactide and polyvinyl alcohol, typically comprising 1-35% by weight polylactide and approximately from 65% to 99% by weight polyvinyl alcohol, if the material is to be water-dispersible, or water-soluble.

It may be preferred that the polymer present in the film is from 60% to 98% hydrolysed, preferably 80% to 90%, to improve the dissolution of the material.

Suitable examples of commercially available water-soluble films include polyvinyl alcohol and partially hydrolysed polyvinyl acetate, alginates, cellulose ethers such as carboxymethylcellulose and methylcellulose, polyethylene oxide, polyacrylates and combinations thereof. Most preferred are films which comprises PVA polymers and have similar properties to films that are known under the trade reference M8630, as sold by Chris-Craft Industrial Products of Gary, Indiana, US. Other preferred films suitable for use herein have similar properties to films that are known under the trade reference PT film or the K-series of films supplied by Aicello, or VF-HP film supplied by Kuraray.

The film herein may comprise other additive ingredients than the polymer or polymer material. For example, it may be beneficial to add plasticisers, for example glycerol, ethylene glycol, diethyleneglycol, propylene glycol, sorbitol and mixtures thereof, additional water, disintegrating aids. It may be useful when the pouched composition is a detergent composition, that the pouch or compartment material itself comprises a detergent additive to be delivered to the wash water, for example organic polymeric soil release agents, dispersants, dye transfer inhibitors.

Process

The process for preparing water-soluble pouches, herein referred to as “the process” comprises the step of shaping pouches from said water-soluble film in a series of molds, wherein said molds are positioned in an interlocking manner.

By shaping, it is typically meant that the water soluble film is placed onto and into the molds, for example, the film may be vacuum pulled into the molds, so that said film is flush with the inner walls of the molds. This is commonly known as vacuum forming. Another preferred method is thermo-forming to get the film to adopt the shape of the mold.

Thermo-forming typically involves the step of formation of an open pouch in a mold under application of heat, which allows the film used to make the pouches to take on the shape of the molds.

Vacuum-forming typically involves the step of applying a (partial) vacuum (reduced pressure) on a mold which sucks the film into the mold and ensures the film adopts the shape of the mold. The pouch forming process may also be done by first heating the film and then applying reduced pressure, e.g. (partial) vacuum.

The film is typically sealed by any sealing means. For example, by heat sealing, wet sealing or by pressure sealing. In a preferred embodiment, a sealing source is contacted to the film and heat or pressure is applied to the film, and the film is sealed. The sealing source may be a solid object, for example a metal, plastic or wood object. If heat is applied to the film during the sealing process, then said sealing source is typically heated to a temperature of from 40° C. to 200° C. If pressure is applied to the film during the sealing process, then the sealing source typically applies a pressure of from 1×10⁴ Nm⁻² to 1×10⁶ Nm⁻², to the film.

The same piece of film may be folded, and sealed to form pouches. Typically more than piece of film is used in the process herein. For example, a first piece of the water soluble film may be vacuum pulled into the molds so that said film is flush with the inner walls of the molds. A second piece of water-soluble film may be positioned such that it at least partially overlaps, preferably completely overlaps, with the first piece of film. The first piece of film and second piece of film are sealed together. The first piece of film and second piece of film can be the same type of film or can be different types of film.

If the pouches obtained from the process herein contain a composition, then in a preferred embodiment of the present invention, a first piece of the water soluble film may be vacuum pulled into the molds so that said film is flush with the inner walls of the molds. A composition may be poured into the molds, and a second water-soluble film may be placed over the molds with the composition and the first piece of film and second piece of film are sealed together to form pouches, typically in such a manner as to at least partially enclose, preferably completely enclose, the composition.

Preferably the first film is stretched, as defined hereinafter. Typically, the second film is not as stretched as the first film.

Preferably, the first film has an unstretched thickness of from 50 micrometers to 200 micrometers, preferably from 60 micrometers, or from 70 micrometers, and preferably to 150 micrometers, or to 100 micrometers, or to 90 micrometers, or to 80 micrometers. Preferably the second film has an unstretched thickness of from 5 micrometers to 40 micrometers, preferably from 10 micrometers, or from 20 micrometers, or from 30 micrometers.

It may be preferred that the film, and preferably the pouch as a whole, is stretched during formation of the pouch, such that the resulting pouch is at least partially stretched. This is to reduce the amount of film required to enclose the volume space of the pouch.

When the film is stretched the film thickness decreases. The degree of stretching indicates the amount of stretching of the film by the reduction in the thickness of the film. For example, if by stretching the film, the thickness of the film is exactly halved then the stretch degree of the stretched film is 100%. Also, if the film is stretched so that the film thickness of the stretched film is exactly a quarter of the thickness of the unstretched film then the stretch degree is exactly 200%. Typically and preferably, the thickness and hence the degree of stretching is non-uniform over the pouch, due to the formation and closing process. For example, when a water-soluble film is positioned in a mold and an indent is formed by vacuum forming (and then filled with the components of a composition and then closed), the part of the film in the bottom of the mold, furthest removed from the points of closing will be stretched more than in the top part. Preferably, the film which is furthest away from the opening, e.g. the film in the bottom of the mold, will be stretched more and be thinner than the film closest by the opening, e.g. at the top part of the mold.

Another advantage of stretching the film, is that the stretching action, when forming the shape of the pouch and/or when closing the pouch, stretches the pouch non-uniformly, which results in a pouch which has a non-uniform thickness. This allows control of the dissolution of water-soluble pouches herein, and for example, sequential release of the components of a detergent composition enclosed by the pouch to the water.

Preferably, the pouch is stretched such that the thickness variation in the pouch formed of the stretched water-soluble film is from 10 to 1000%, preferably 20% to 600%, or even 40% to 500% or even 60% to 400%. This can be measured by any method, for example by use of an appropriate micrometer. Preferably the pouch is made from a water-soluble film that is stretched, said film has a stretch degree of from 40% to 500%, preferably from 40% to 200%.

The process herein may be used to prepare pouches which have an internal volume that is divided into more than one compartment, typically known as a multi-compartment pouches. In this preferred process, the film is folded at least twice, or at least three pieces of film are used, or at least two pieces of film are used wherein at least one piece of film is folded at least once. The third piece of film, or a folded piece of film, creates a barrier layer that, when the pouch is sealed, divides the internal volume of said pouch into at least two compartments.

The process herein can be used to prepare water-soluble multi-compartment pouches by, fitting a first piece of the water soluble film into a series of molds, for example the first piece of film may be vacuum pulled into the molds so that said film is flush with the inner walls of the molds. A composition is typically poured into the molds. A pre-sealed compartment made of a water-soluble film can then be placed over the molds containing the composition. These pre-sealed compartments and said first piece of film may be sealed together to form multi-compartment pouches, for example, dual-compartment pouches.

Pouch Obtained Therefrom

The pouches obtained from the process herein are water-soluble. Water-soluble typically being determined by the gravimetric method described hereinbefore.

The pouch is typically a closed structure, made of a water-soluble film described herein, typically enclosing a volume space which preferably comprises a composition. Said composition is described in more detail hereinafter. This is preferably suitable to hold a composition, e.g. without allowing the release of the composition from the pouch prior to contact of the pouch to water. The exact execution will depend on for example, the type and amount of the composition in the pouch, the number of compartments in the pouch, the characteristics required from the pouch to hold, protect and deliver or release the compositions.

The volume space of the pouch can be divided into more than one compartment. Pouches having a volume space which is divided into more than one compartment are herein referred to as multi-compartment pouches. If these multi-compartment pouches contain a composition, then different compartments may contain different ingredients of the composition. For example, incompatible ingredients may be contained in different compartments.

The pouches may be of such a size that it conveniently contains either a unit dose amount of the composition herein, suitable for the required operation, for example one wash, or only a partial dose, to allow the consumer greater flexibility to vary the amount used, for example depending on the size and/or degree of soiling of the wash load. The shape and size of the pouch is typically determined, at least to some extent, by the shape and size of the mold.

Composition Contained Therein

The pouch typically comprises a composition, typically said composition is contained in the inner volume space of the pouch.

The compositions herein are cleaning compositions or fabric care compositions, preferably hard surface cleaners, more preferably laundry or dish washing compositions, including pre-treatment or soaking compositions and rinse additive compositions.

Typically, the composition comprises such an amount of a cleaning composition, that one or a multitude of the pouched compositions is or are sufficient for one wash.

The composition can contain any active cleaning ingredient. Particularly preferred are active ingredients such as chelating agents, builders, enzymes, perfumes, bleaches, bleach activators, fabric softeners, fabric conditioners, surfactants, other fabric conditioners, antibacterial agents, effervescence sources, brighteners, photo-bleaches. Fabric care compositions preferably comprise at least one or more softening agents, such as quaternary ammonium compounds and/or softening clays, and preferably additional agent such as anti-wrinkling aids, perfumes and chelating agents.

Preferably the composition comprises a chelating agent. It is also preferred that the composition is free from borate. Preferably, the composition comprises at least one surfactant and at least one building agent.

It may be possible that part or all of the components of the composition are not pre-granulated, such as agglomerated, spray-dried, extruded, prior to incorporation into the compartment, and that the composition is a mixture of dry-mixed powder ingredients or even raw materials. Preferred may be that for example less than 60% or even less than 40% or even less than 20% of the component is a free-flowable pre-granulated granules.

If the pouches obtained by the process herein comprise more than one compartment, then incompatible ingredients of a composition contained by said pouches, if present, may be contained in different compartments.

Preferred Ingredients of the Composition

The preferred amounts of ingredients described herein are % by weight of the composition herein as a whole.

Detersive Surfactants

Nonionic Alkoxylated Surfactant

Essentially any alkoxylated nonionic surfactants can be comprised by the composition herein. These nonionic surfactants are in addition to the alkoxylated compound of the invention. The ethoxylated and propoxylated nonionic surfactants are preferred. Preferred alkoxylated surfactants can be selected from the classes of the nonionic condensates of alkyl phenols, nonionic ethoxylated alcohols, nonionic ethoxylated/propoxylated fatty alcohols, nonionic ethoxylate/propoxylate condensates with propylene glycol, and the nonionic ethoxylate condensation products with propylene oxide/ethylene diamine adducts.

Highly preferred are nonionic alkoxylated alcohol surfactants, being the condensation products of aliphatic alcohols with from 1 to 75 moles of alkylene oxide, in particular about 50 or from 1 to 15 moles, preferably to 11 moles, particularly ethylene oxide and/or propylene oxide, are highly preferred nonionic surfactants. The alkyl chain of the aliphatic alcohol can either be straight or branched, primary or secondary, and generally contains from 6 to 22 carbon atoms. Particularly preferred are the condensation products of alcohols having an alkyl group containing from 8 to 20 carbon atoms with from 2 to 9 moles and in particular 3 or 5 moles, of ethylene oxide per mole of alcohol.

Nonionic Polyhydroxy Fatty Acid Amide Surfactant

Polyhydroxy fatty acid amides are highly preferred nonionic surfactant comprised by the composition, in particular those having the structural formula R²CONR¹Z wherein: R1 is H, C₁₋₁₈, preferably C₁-C₄ hydrocarbyl, 2-hydroxy ethyl, 2-hydroxy propyl, ethoxy, propoxy, or a mixture thereof, preferable C1-C4 alkyl, more preferably C₁ or C₂ alkyl, most preferably C₁ alkyl (i.e., methyl); and R₂ is a C₅-C₃₁ hydrocarbyl, preferably straight-chain C₅-C₁₉ or C₇-C₁₉ alkyl or alkenyl, more preferably straight-chain C₉-C₁₇ alkyl or alkenyl, most preferably straight-chain C₁₁-C₁₇ alkyl or alkenyl, or mixture thereof; and Z is a polyhydroxyhydrocarbyl having a linear hydrocarbyl chain with at least 3 hydroxyls directly connected to the chain, or an alkoxylated derivative (preferably ethoxylated or propoxylated) thereof. Z preferably will be derived from a reducing sugar in a reductive amination reaction; more preferably Z is a glycityl.

A highly preferred nonionic polyhydroxy fatty acid amide surfactant for use herein is a C₁₂-C₁₄, a C₁₅-C₁₇ and/or C₁₆-C₁₈ alkyl N-methyl glucamide.

It may be particularly preferred that the composition herein comprises a mixture of a C₁₂-C₁₈ alkyl N-methyl glucamide and condensation products of an alcohol having an alkyl group containing from 8 to 20 carbon atoms with from 2 to 9 moles and in particular 3 or 5 moles, of ethylene oxide per mole of alcohol.

The polyhydroxy fatty acid amide can be prepared by any suitable process. One particularly preferred process is described in detail in WO 9206984. A product comprising about 95% by weight polyhydroxy fatty acid amide, low levels of undesired impurities such as fatty acid esters and cyclic amides, and which is molten typically above about 80° C., can be made by this process.

Nonionic Fatty Acid Amide Surfactant

Fatty acid amide surfactants or alkoxylated fatty acid amides can also be comprised by the composition herein. They include those having the formula: R⁶CON(R⁷)(R⁸ ) wherein R⁶ is an alkyl group containing from 7 to 21, preferably from 9 to 17 carbon or even 11 to 13 carbon atoms and R⁷ and R⁸ are each individually selected from the group consisting of hydrogen, C₁-C₄ alkyl, C₁-C₄ hydroxyalkyl, and —(C₂H₄O)ₓH, where x is in the range of from 1 to 11, preferably 1 to 7, more preferably form 1-5, whereby it may be preferred that R⁷ is different to R⁸, one having x being 1 or 2, one having x being from 3 to 11 or preferably 5.

Nonionic Alkyl Esters of Fatty Acid Surfactant

Alkyl esters of fatty acids can also be comprised by the composition herein. They include those having the formula: R⁹COO(R¹⁰) wherein R⁹ is an alkyl group containing from 7 to 21, preferably from 9 to 17 carbon or even 11 to 13 carbon atoms and R¹⁰ is a C₁ -C₄ alkyl, C₁ -C₄ hydroxyalkyl, or —(C₂H₄O)ₓH, where x is in the range of from 1 to 11, preferably 1 to 7, more preferably form 1-5, whereby it may be preferred that R¹⁰ is a methyl or ethyl group.

Nonionic Alkylpolysaccharide Surfactant

Alkylpolysaccharides can also be comprised by the composition herein, such as those disclosed in U.S. Pat. No. 4,565,647, Llenado, issued Jan. 21, 1986, having a hydrophobic group containing from 6 to 30 carbon atoms and a polysaccharide, e.g., a polyglycoside, hydrophilic group containing from 1.3 to 10 saccharide units.

Preferred alkylpolyglycosides have the formula

R²O(CₙH₂ₙO)t(glycosyl)ₓ

wherein R² is selected from the group consisting of alkyl, alkylphenyl, hydroxyalkyl, hydroxyalkylphenyl, and mixtures thereof in which the alkyl groups contain from 10 to 18 carbon atoms; n is 2 or 3; t is from 0 to 10, and x is from 1.3 to 8. The glycosyl is preferably derived from glucose.

Polyethylene Propylene Glycols

The composition herein may comprise polyethylene and/or propylene glycol, particularly those of molecular weight 1000-10000, more particularly 2000 to 8000 and most preferably about 4000.

Anionic Surfactant

The composition herein, preferably comprises one or more anionic surfactants. Any anionic surfactant useful for detersive purposes is suitable. Examples include salts (including, for example, sodium, potassium, ammonium, and substituted ammonium salts such as mono-, di- and triethanolamine salts) of the anionic sulphate, sulphonate, carboxylate and sarcosinate surfactants. Anionic sulphate surfactants are preferred.

Other anionic surfactants include the isethionates such as the acyl isethionates, N-acyl taurates, fatty acid amides of methyl tauride, alkyl succinates and sulfosuccinates, monoesters of sulfosuccinate (especially saturated and unsaturated C₁₂-C₁₈ monoesters) diesters of sulfosuccinate (especially saturated and unsaturated C₆-C₁₄ diesters), N-acyl sarcosinates. Resin acids and hydrogenated resin acids are also suitable, such as rosin, hydrogenated rosin, and resin acids and hydrogenated resin acids present in or derived from tallow oil.

Anionic Sulphate Surfactant

Anionic sulphate surfactants suitable for use herein include the linear and branched primary and secondary alkyl sulphates, alkyl ethoxysulphates, fatty oleoyl glycerol sulphates, alkyl phenol ethylene oxide ether sulphates, the C₅-C₁₇ acyl-N-(C₁-C₄ alkyl and —N—(C₁-C₂ hydroxyalkyl) glucamine sulphates, and sulphates of alkylpolysaccharides such as the sulphates of alkylpolyglucoside (the nonionic non-sulphated compounds being described herein).

Alkyl sulphate surfactants are preferably selected from the linear and branched primary C₉-C₂₂ alkyl sulphates, more preferably the C₁₁-C₁₅ branched chain alkyl sulphates and the C₁₂-C₁₄ linear chain alkyl sulphates.

Alkyl ethoxysulfate surfactants are preferably selected from the group consisting of the C₁₀-C₁₈ alkyl sulphates which have been ethoxylated with from 0.5 to 50 moles of ethylene oxide per molecule. More preferably, the alkyl ethoxysulfate surfactant is a C₁₁-C₁₈, most preferably C₁₁-C₁₅ alkyl sulphate which has been ethoxylated with from 0.5 to 7, preferably from 1 to 5, moles of ethylene oxide per molecule.

Anionic Sulphonate Surfactant

Anionic sulphonate surfactants suitable for use herein include the salts of C₅-C₂₀ linear or branched alkylbenzene sulphonates, alkyl ester sulphonates, in particular methyl ester sulphonates, C₆-C₂₂ primary or secondary alkane sulphonates, C₆-C₂₄ olefin sulphonates, sulphonated polycarboxylic acids, alkyl glycerol sulphonates, fatty acyl glycerol sulphonates, fatty oleyl glycerol sulphonates, and any mixtures thereof.

Anionic Carboxylate Surfactant

Suitable anionic carboxylate surfactants include the alkyl ethoxy carboxylates, the alkyl polyethoxy polycarboxylate surfactants and the soaps (‘alkyl carboxyls’), especially certain secondary soaps as described herein.

Suitable alkyl ethoxy carboxylates include those with the formula RO(CH₂CH₂O)ₓCH₂COO⁻M⁺ wherein R is a C₆ to C₁₈ alkyl group, x ranges from 0 to 10, and the ethoxylate distribution is such that, on a weight basis, the amount of material where x is 0 is less than 20% and M is a cation. Suitable alkyl polyethoxy polycarboxylate surfactants include those having the formula RO—(CHR₁—CHR₂—O)_{X}—R₃ wherein R is a C₆ to C₁₈ alkyl group, x is from 1 to 25, R₁ and R₂ are selected from the group consisting of hydrogen, methyl acid radical, succinic acid radical, hydroxysuccinic acid radical, and mixtures thereof, and R₃ is selected from the group consisting of hydrogen, substituted or unsubstituted hydrocarbon having between 1 and 8 carbon atoms, and mixtures thereof.

Suitable soap surfactants include the secondary soap surfactants which contain a carboxyl unit connected to a secondary carbon. Preferred secondary soap surfactants for use herein are water-soluble members selected from the group consisting of the water-soluble salts of 2-methyl-1-undecanoic acid, 2-ethyl-1-decanoic acid, 2-propyl-1-nonanoic acid, 2-butyl-1-octanoic acid and 2-pentyl-1-heptanoic acid. Certain soaps may also be included as suds suppressers.

Alkali Metal Sarcosinate Surfactant

Other suitable anionic surfactants are the alkali metal sarcosinates of formula R—CON(R¹)CH₂COOM, wherein R is a C₅-C₁₇ linear or branched alkyl or alkenyl group, R¹ is a C₁-C₄ alkyl group and M is an alkali metal ion. Preferred examples are the myristyl and oleoyl methyl sarcosinates in the form of their sodium salts.

Cationic Surfactant

Another preferred surfactant is a cationic surfactant, which may preferably be present at a level of from 0. 1% to 60% by weight of the composition herein, more preferably from 0.4% to 20%, most preferably from 0.5% to 5% by weight of the composition herein.

When present, the ratio of the anionic surfactant to the cationic surfactant is preferably from 35:1 to 1:3, more preferably from 15:1 to 1:1. most preferably from 10:1 to 1:1.

Preferably the cationic surfactant is selected from the group consisting of cationic ester surfactants, cationic mono-alkoxylated amine surfactants, cationic bis-alkoxylated amine surfactants and mixtures thereof.

Amphoteric Surfactant

Suitable amphoteric surfactants for use herein include the amine oxide surfactants and the alkyl amphocarboxylic acids.

Zwitterionic Surfactant

Zwitterionic surfactants can also be comprised by the composition herein. These surfactants can be broadly described as derivatives of secondary and tertiary amines, derivatives of heterocyclic secondary and tertiary amines, or derivatives of quaternary ammonium, quaternary phosphonium or tertiary sulfonium compounds. Betaine and sultaine surfactants are exemplary zwitterionic surfactants for use herein.

Water-Soluble Building Agent

The composition herein may comprises a water-soluble building agent, typically present at a level of from 0% to 36% by weight, preferably from 1% to 35% by weight, more preferably from 10% to 35%, even more preferably from 12% to 30% by weight of the composition or particle. Preferably, the water-soluble builder compound is an alkali or earth alkali metal salt of phosphate present at the level described above.

Suitable examples of water-soluble phosphate builders are the alkali metal tripolyphosphates, sodium, potassium and ammonium pyrophosphate, sodium and potassium and ammonium pyrophosphate, sodium and potassium orthophosphate, sodium polymeta/phosphate in which the degree of polymerisation ranges from about 6 to 21, and salts of phytic acid.

Other typical water-soluble building agents include the water soluble monomeric polycarboxylates, or their acid forms, homo or copolymeric polycarboxylic acids or their salts in which the polycarboxylic acid comprises at least two carboxylic radicals separated from each other by not more that two carbon atoms, borates, phosphates, and mixtures of any of the foregoing.

Water Insoluble Building Agent

The composition herein preferably comprises a water-insoluble building agent. Examples of water insoluble builders include the sodium aluminosilicates.

Suitable aluminosilicate zeolites have the unit cell formula Na_{z}[(AlO₂)_{z}(SiO₂)y]. xH₂O wherein z and y are at least 6; the molar ratio of z to y is from 1.0 to 0.5 and x is at least 5, preferably from 7.5 to 276, more preferably from 10 to 264. The aluminosilicate material are in hydrated form and are preferably crystalline, containing from 10% to 28%, more preferably from 18% to 22% water in bound form.

Peroxide Source

Another preferred ingredient is a perhydrate bleach, such as salts of percarbonates, particularly the sodium salts, and/or organic peroxyacid bleach precursor. It has been found that when the pouch or compartment is formed from a material with free hydroxy groups, such as PVA, the preferred bleaching agent comprises a percarbonate salt and is preferably free form any perborate salts or borate salts. It has been found that borates and perborates interact with these hydroxy-containing materials and reduce the dissolution of the materials and also result in reduced performance.

Inorganic perhydrate salts are a preferred source of peroxide. Preferably these salts are present at a level of from 0.01% to 50% by weight, more preferably of from 0.5% to 30% by weight of the composition or component.

Examples of inorganic perhydrate salts include percarbonate, perphosphate, persulfate and persilicate salts. The inorganic perhydrate salts are normally the alkali metal salts. The inorganic perhydrate salt may be included as the crystalline solid without additional protection. For certain perhydrate salts however, the preferred executions of such granular compositions utilize a coated form of the material which provides better storage stability for the perhydrate salt in the granular product. Suitable coatings comprise inorganic salts such as alkali metal silicate, carbonate or borate salts or mixtures thereof, or organic materials such as waxes, oils, or fatty soaps.

Alkali metal percarbonates, particularly sodium percarbonate are preferred perhydrates herein. Sodium percarbonate is an addition compound having a formula corresponding to 2Na₂CO₃.3H₂O₂, and is available commercially as a crystalline solid.

Potassium peroxymonopersulfate is another inorganic perhydrate salt of use in the compositions herein.

Bleach Activator

The composition herein preferably comprises a bleach activator, preferably comprising an organic peroxyacid bleach precursor. It may be preferred that the composition comprises at least two peroxy acid bleach precursors, preferably at least one hydrophobic peroxyacid bleach precursor and at least one hydrophilic peroxy acid bleach precursor, as defined herein. The production of the organic peroxyacid occurs then by an in situ reaction of the precursor with a source of hydrogen peroxide.

The bleach activator may alternatively, or in addition comprise a preformed peroxy acid bleach.

Preferably, at least one of the bleach activators, preferably a peroxy acid bleach precursor having an average particle size, by weight, of from 600 microns to 1400 microns, preferably from 700 microns to 1100 microns is present in the composition herein.

Hereby, it may be preferred that at least 80%, preferably at least 90% or even at least 95% or even substantially 100% of the component or components comprising the bleach activator have a particle size of from 300 microns to 1700 microns, preferably from 425 microns to 1400 microns.

The hydrophobic peroxy acid bleach precursor preferably comprises a compound having a oxy-benzene sulphonate group, preferably NOBS, DOBS, LOBS and/or NACA-OBS, as described herein.

The hydrophilic peroxy acid bleach precursor preferably comprises TAED, as described herein.

Organic Peroxyacid Bleaching System

The composition herein preferably comprises an organic peroxyacid precursor. The production of the organic peroxyacid may occur by an in situ reaction of such a precursor with the percarbonate source. In an alternative preferred execution a pre-formed organic

Chelating Agents

The composition herein, preferably comprises a chelating agent. By chelating agent it is meant herein components which act to sequester (chelate) heavy metal ions. These components may also have calcium and magnesium chelation capacity, but preferentially they show selectivity to binding heavy metal ions such as iron, manganese and copper.

Chelating agents are generally present at a level of from 0.05% to 2%, preferably from 0.1% to 1.5%, more preferably from 0.25% to 1.2% and most preferably from 0.5% to 1% by weight of the composition herein.

Enzyme

Another preferred optional ingredient useful in the composition herein, is one or more additional enzymes.

Preferred additional enzymatic materials include the commercially available lipases, cutinases, amylases, neutral and alkaline proteases, esterases, cellulases, pectinases, lactases and peroxidases conventionally incorporated into compositions. Suitable enzymes are discussed in U.S. Pat. Nos. 3,519,570 and 3,533,139.

Suds Suppressing System

The composition may comprise a suds suppresser at a level less than 10%, preferably 0.001% to 10%, preferably from 0.01% to 8%, most preferably from 0.05% to 5%, by weight of the composition Preferably the suds suppresser is either a soap, paraffin, wax, or any combination thereof. If the suds suppresser is a suds suppressing silicone, then the detergent composition preferably comprises from 0.005% to 0.5% by weight a suds suppressing silicone.

Suitable suds suppressing systems for use herein may comprise essentially any known antifoam compound, including, for example silicone antifoam compounds and 2-alkyl alcanol antifoam compounds.

By antifoam compound it is meant herein any compound or mixtures of compounds which act such as to depress the foaming or sudsing produced by a solution of the composition herein, particularly in the presence of agitation of that solution.

Particularly preferred antifoam compounds for use herein are silicone antifoam compounds defined herein as any antifoam compound including a silicone component. Such silicone antifoam compounds also typically contain a silica component. The term “silicone” as used herein, and in general throughout the industry, encompasses a variety of relatively high molecular weight polymers containing siloxane units and hydrocarbyl group of various types. Preferred silicone antifoam compounds are the siloxanes, particularly the polydimethylsiloxanes having trimethylsilyl end blocking units. Preferably the composition herein comprises from 0.005% to 0.5% by weight suds suppressing silicone.

Polymeric Dye Transfer Inhibiting Agents

The composition herein may also comprise from 0.01% to 10%, preferably from 0.05% to 0.5% by weight of polymeric dye transfer inhibiting agents. These polymeric dye transfer inhibiting agents are in addition to the polymeric material of the water-soluble film.

The polymeric dye transfer inhibiting agents are preferably selected from polyamine N-oxide polymers, copolymers of N-vinylpyrrolidone and N-vinylimidazole, polyvinylpyrrolidonepolymers or combinations thereof.

Cationic Fabric Softening Agents

Cationic fabric softening agents are preferably present in the composition herein. Suitable cationic fabric softening agents include the water insoluble tertiary amines or dilong chain amide materials as disclosed in GB-A-1 514 276 and EP-B-0 011 340. Preferably, these water-insoluble tertiary amines or dilong chain amide materials are comprised by the solid component of the composition herein.

Cationic fabric softening agents are typically incorporated at total levels of from 0.5% to 15% by weight, normally from 1% to 5% by weight.

Other Optional Ingredients

Other optional ingredients suitable for inclusion in the composition herein include optical brighteners, perfumes, colours and filler salts, with sodium sulphate being a preferred filler salt.

### EXAMPLES

Abbreviations Used in Examples

In the detergent compositions, the abbreviated component identifications have the following meaning:

| Abbreviation | Description |
|---|---|
| Alkoxylated alcohol: | Tallow alcohol ethylene oxide condensate of type tallow alcohol, |
| | condensed with an average of from 50 to 100 moles of ethylene |
| | oxide |
| CxyAS: | Sodium C₁ₓ-C_{1y} alkyl sulphate |
| CxyEz: | C₁ₓ-C_{1y} predominantly linear primary alcohol condensed with an |
| | average of z moles of ethylene oxide |
| CxyEzS: | Sodium C₁ₓ-C_{1y} alkyl sulfate condensed with z moles of |
| | ethylene oxide |
| FAS: | Fatty alkyl sulfate |
| LAS: | Sodium linear C₁₁-C₁₃ alkyl benzene sulfonate |
| QAS(1): | R₂.N⁺(CH₃)₂(C₂H₄OH), wherein R₂ = C₁₂-C₁₄ |
| QAS(2): | R₂.N⁺(CH₃)₂(C₂H₄OH), wherein R₂ = C₈-C₁₁ |
| Carbonate: | Anhydrous sodium carbonate |
| Silicate: | Amorphous sodium silicate (SiO₂:Na₂O = from 2:1 to 4:1) |
| Sulfate: | Anhydrous sodium sulfate |
| Citric acid: | Anhydrous citric |
| NaSKS-6: | Crystalline layered silicate of formula d-Na₂Si₂O₅ |
| STPP: | Anhydrous sodium tripolyphosphate |
| Zeolite A: | Hydrated sodium aluminosilicate of formula |
| | Na₁₂(AlO₂SiO₂)₁₂.27H2O having a primary particle size in the |
| | range of from 0.1 to 10 micrometers (weight expressed on an |
| | anhydrous basis) |
| DTPA: | Diethylene triamine pentaacetic acid |
| DTPMP: | Diethylene triamine penta(methylene phosphonate), supplied by |
| | Monsanto under the tradename Dequest 2060. |
| EDDS: | Ethylenediamine-N′N′-disuccinic acid, (S,S) isomer in the form of |
| | a sodium salt |
| HEDP: | 1,1-hydroxyethane diphosphonic acid |
| Mg sulfate: | Anhydrous magnesium sulfate |
| Percarbonate: | Sodium percarbonate of the nominal formula 2Na₂CO₃.3H₂O₂ |
| NAC-OBS: | (6-nonamidocaproyl) oxybenzene sulfonate |
| NOBS: | Nonanoyloxybenzene sulfonate |
| TAED: | Tetraacetylethylenediamine |
| Photobleach(1): | Sulfonated zinc phthalocyanine |
| Photobleach(2): | Sulfonated alumino phthalocyanine |
| Brightener(1): | Disodium 4,4′-bis-(2-sulfostyryl)biphenyl, supplied by Ciba-Geigy |
| | under the tradename Tinopal CBS |
| Brightener(2): | Disodium 4,4′-bis-((4-anilino-6-morpholino-s-triazin-2-yl)- |
| | amino}-2,2′-stilbenedisulfonate |
| PVI: | Polyvinyl imidosole having a weight average molecular weight of |
| | 20000 |
| PVP: | Polyvinyl pyrolidone polymer having a weight average molecular |
| | weight of 60000 |
| PVNO: | Polyvinyl pyridine N-oxide polymer having a weight average |
| | molecular weight of 50000 |
| PVPVI: | Copolymer of polyvinyl pyrolidone and vinyl imidazol, having a |
| | molecular weight of 20000 |
| Dye fixative: | Oligomer produced by the condensation of imidazole and |
| | epichlorhydrin |
| EMC: | Ester modified cellulose |
| PEO: | Polyethylene oxide having a weight average molecular weight of |
| | from 100000 to 1000000 |
| Clay: | Smectite clay |
| CMC: | Sodium carboxymethyl cellulose |
| MA/AA(1): | Copolymer of maleic/acrylic acid, having a weight average |
| | molecular weight of from 50000 to 90000, wherein the ratio of |
| | maleic to acrylic acid is from 1:3 to 1:4 |
| QEA(1): | bis((C₂H₅O)(C₂H₄O)n)(CH₃)—N+—CₓH₂ₓ-N+—(CH₃)— |
| | bis((C₂H₅O)(C₂H₄O)n), wherein n = from 20 to 30, and x = from 3 to |
| | 8 |
| QEA(2): | sulphonated or sulphated bis((C₂H₅O)(C₂H₄O)n)(CH₃)—N+—CₓH₂ₓ— |
| | N+—(CH₃)-bis((C₂H₅O)(C₂H₄O)n), wherein n = from 20 to 30, and |
| | x = from 3 to 8 |
| SRP(1): | Anionically end capped polyesters |
| SRP(2): | Copolymer of dimethylterephthalate/propylene glycol/methyl |
| | capped polyethyl glycol |
| Amylase: | Amylolytic enzyme having 1.6% by weight of active enzyme, |
| | supplied by NOVO Industries A/S under the tradename Termamyl |
| | 120T |
| Cellulase: | Cellulytic enzyme having 0.23% by weight of active enzyme, |
| | supplied by NOVO Industries A/S under the tradename Carezyme |
| Silicone antifoam: | Polydimethyl siloxane foam controller with siloxane-oxyalkylene |
| | copolymer as dispersing agent, wherein the ratio of said foam |
| | controller to said dispersing agent is from 10:1 to 100:1 |
| Soap: | Sodium linear alkyl carboxylate which is derived from a mixture of |
| | tallow and coconut fatty acids, wherein the ratio of tallow to coco |
| | fatty acids is from 70:30 to 99:1 |
| Perfume particle: | Perfume particle comprising a perfume and a carrier molecule |
| Encap Perfume: | Encapsulated perfume |

### Example I

A sheet of water-soluble film (Chris-Craft M-8630 film) is placed over a series of 12 hexagonal shaped molds having six sides of equal length (each being 22.5 mm long), and having six corners having the same internal angle of 120°, the molds also have rounded (hemispherical-like) bottoms of a depth of 28 mm. A 1 mm thick layer of rubber is present around the edge of each mold. The molds have some holes in the mold material to allow a vacuum to be applied. The molds are positioned in three rows, each row having four molds. The molds are positioned in an interlocking manner such that the edges of the adjoining molds touch.

A vacuum is applied to pull a single piece of film into the molds so that the film is flush with the inner surface of the molds. Solid detergent composition is poured into each mold so that the molds are filled between 95% to 100%.

Next, another sheet of water-soluble film (Chris-Craft M-8630 film) is placed over the top of the molds containing the solid composition, and is sealed to the first layer of fi lm by applying a piece of flat metal of a size to completely cover the whole series of molds, and heating that metal under moderate pressure onto the pieces of rubber at the edges of the molds to heat-seal the two pieces of film together. The piece of metal is typically heated to a temperature of 140-146° C. and applied for up to 5 seconds.

The film is then cut to produce individual single pouches.

### Example II

The following compositions are in accordance with the invention. Said compositions are enclosed within the pouches made of water-soluble film (Chris-Craft M-8630 film). The pouches are made by the process described in example I.

| Ingredient | A | B | C | D | E | F | G | H |
|---|---|---|---|---|---|---|---|---|
| Alkoxylated | 0.02 | 0.1 | 0.01 | 0.05 | 0.15 | 0.08 | 0.06 | 0.04 |
| alcohol | | | | | | | | |
| C28AS | 0.5 | 0.6 | 1 | 0.2 | | | | |
| C28E3 | | | | | | | | |
| C28E5 | 3 | 5 | 7 | 2 | 4 | 6.5 | 5 | 3 |
| C25E3S | 1 | 0.5 | 0.8 | 1.2 | | | | |
| FAS | 2 | 0.5 | 0.2 | 1.5 | 0.2 | 0.8 | 1 | 0.6 |
| LAS | 5 | 6 | 6.5 | 5 | 7 | 5.5 | 6 | 5.5 |
| Carbonate | 16 | 15 | 20 | 18 | 25 | 30 | 15 | 22 |
| Silicate | 0.05 | 0.1 | 0.08 | 0.2 | 0.05 | 0.1 | 0.2 | 0.15 |
| Sulfate | 22 | 20 | 17 | 15 | 14 | 12 | 20 | 16 |
| Citric Acid | 2.5 | 2 | 4 | 1.5 | 5 | 3 | 3.5 | 4 |
| NaSKS-6 | 2 | 4 | 3.5 | 5 | 2.5 | 3 | 4 | 4.5 |
| Zeolite A | 15 | 20 | 17.5 | 15 | 18 | 16 | 14 | 15 |
| EDDS | 0.1 | 0.5 | 0.05 | 0.15 | 0.25 | 0.2 | 0.1 | 0.15 |
| HEDP | 0.1 | 0.05 | 0.2 | 0.15 | 0.1 | 0.1 | 0.3 | 0.2 |
| Mg Sulfate | 0.5 | 0.4 | 0.3 | 0.3 | 0.4 | 0.2 | 0.5 | 0.25 |
| Percarbonate | 12 | 15 | 18 | 10 | 8 | 12 | 10 | 8 |
| NAC_OBS | | | | | | | 2 | |
| NOBS | | | | | | | | 2 |
| TAED | 2.5 | 2 | 1.5 | 3 | 1 | 5 | | |
| Photobleach(1) | 0.001 | 0.005 | | | 0.002 | | | |
| Photobleach(2) | | | 0.005 | 0.001 | 0.002 | | | |
| Brightener(1) | 0.02 | 0.1 | 0.08 | 0.05 | 0.1 | | | |
| Brightener(2) | 0.02 | | | 0.05 | | 0.05 | 0.1 | 0.06 |
| EMC | | | | 0.6 | 0.4 | 1.2 | 0.8 | |
| CMC | 0.15 | 0.1 | 0.2 | 0.5 | 0.05 | 0.1 | 0.25 | 0.1 |
| MA/AA(1) | 1.5 | 2.5 | 2 | 2.5 | 1 | 3 | 0.5 | 1.0 |
| QEA(1) | 0.5 | | 0.3 | 1.2 | 1.0 | | 0.4 | 1.0 |
| QEA(2) | | 0.8 | | | | 0.6 | | |
| SRP(1) | 0.1 | | | 0.08 | 0.15 | 0.2 | 0.05 | 0.03 |
| SRP(2) | | 0.15 | 0.1 | | | | | |
| Amylase | 0.1 | | 0.05 | | 0.01 | 0.2 | | |
| Cellulase | | 0.1 | | 0.15 | | 0.05 | 0.01 | |
| Silicone | 0.05 | 0.1 | 0.02 | | 0.08 | 0.01 | 0.05 | 0.03 |
| antifoam | | | | | | | | |
| Soap | 0.6 | 0.5 | 0.1 | 0.05 | 0.3 | 0.4 | 0.5 | 0.5 |
| Perfume | 0.3 | 0.4 | 0.25 | 0.5 | 0.4 | 0.6 | 0.3 | 0.2 |
| particle | | | | | | | | |
| Encap perfume | | | | | 0.1 | 0.2 | | |
| Miscellaneous | to | to | to | to | to | to | to | to |
| | 100% | 100% | 100% | 100% | 100% | 100% | 100% | 100% |

### Example III

The following detergent compositions are in accordance with the invention. Said detergent compositions are enclosed within the pouches made of a water-soluble film (Chris-Craft M-8630 film). The pouches are made by the process described in example I.

| Ingredient | I | J | K | L | M | N | O | P |
|---|---|---|---|---|---|---|---|---|
| Alkoxylated | 0.1 | 0.15 | 0.05 | 0.3 | 0.01 | 0.05 | 0.06 | 0.12 |
| alcohol | | | | | | | | |
| C28E5 | 5 | 3 | 4 | 3.5 | 4.5 | | 2.5 | |
| C28E7 | | 2 | | | | 4 | | 5 |
| FAS | | | | 1 | 2 | 0.1 | 1 | 0.5 |
| LAS | 9 | 7 | 8 | 6 | 5 | 8 | 7 | 6 |
| QAS(1) | | 1 | | 1.5 | 0.5 | | | |
| QAS(2) | | 1 | | | | | | |
| Carbonate | 12 | 20 | 15 | 20 | 10 | 8 | 25 | 24 |
| Silicate | 0.1 | 3 | 0.05 | 5 | 4 | 1.2 | 1.5 | 1 |
| Sulfate | 30 | 20 | 25 | 18 | 30 | 27 | 12 | 16 |
| Citric Acid | 2 | 1 | 1.5 | | 3 | 1 | | 2 |
| NaSKS-6 | 3 | | | 4 | | 2 | | |
| STPP | | 22 | 25 | | 20 | | | 25 |
| Zeolite A | 20 | 0.5 | 1 | 18 | | 16 | 14 | |
| DTPA | | | | 0.4 | | 0.5 | 0.3 | |
| EDDS | 0.1 | 0.2 | 0.05 | 0.1 | 0.15 | 0.2 | 0.08 | 0.12 |
| HEDP | 0.15 | 0.1 | 0.2 | 0.12 | 0.05 | 0.05 | 0.1 | 0.08 |
| Mg Sulfate | 0.3 | 0.4 | | 0.35 | 0.25 | 0.2 | 0.5 | |
| Percarbonate | 10 | 6 | 7 | 7 | 12 | 11 | 10 | 8 |
| NAC_OBS | | | | | | | | 1.5 |
| NOES | | 0.8 | | | | | | |
| TAED | 1.2 | | 0.5 | 1 | 1.8 | 0.8 | 2.4 | |
| Brightener(1) | 0.06 | 0.05 | 0.03 | | | | 0.05 | 0.1 |
| Brightener(2) | | | 0.03 | 0.05 | 0.05 | 0.03 | | |
| PEO | | | | | | 0.15 | 0.2 | 0.25 |
| Clay | | | | | | 8 | 9 | 10 |
| EMC | | | 0.6 | | | 0.5 | 1.2 | 0.8 |
| CMC | 0.1 | 0.2 | | 0.2 | 0.3 | 0.1 | 0.05 | 0.2 |
| MA/AA(1) | | 1 | 0.8 | 2 | 1.5 | 0.5 | 0.3 | 1.2 |
| QEA(1) | 0.5 | 0.1 | 0.4 | | | | | |
| QEA(2) | | 0.3 | | | | | | |
| SRP(1) | | | | 0.2 | | | | |
| SRP(2) | | | | | 0.2 | | | |
| Amylase | | | 0.2 | 0.1 | 0.15 | 0.05 | | |
| Cellulase | 0.1 | 0.2 | | | 0.05 | 0.15 | | |
| Silicone | 0.05 | 0.1 | 0.12 | 0.08 | 0.06 | 0.09 | 0.05 | 0.05 |
| antifoam | | | | | | | | |
| Soap | | | | | | 0.4 | 0.6 | 0.5 |
| Perfume | 0.3 | 0.4 | 0.25 | 0.5 | 0.4 | | | 0.35 |
| particle | | | | | | | | |
| Encap | | | | | | 0.4 | 0.3 | |
| Perfume | | | | | | | | |
| Miscellaneous | to | to | to | to | to | to | to | to |
| | 100% | 100% | 100% | 100% | 100% | 100% | 100% | 100% |

### Example IV

The following compositions are in accordance with the invention. Said compositions are enclosed within the pouches made of water-soluble film (Chris-Craft M-8630 film). The pouches are made by the process described in example I.

| Ingredient | Q | R | S | T | U | V | W | X |
|---|---|---|---|---|---|---|---|---|
| C28E7 | 7 | 6 | 5 | 8 | 7 | 6.5 | 5 | 8 |
| LAS | 10 | 8 | 9 | 12 | 7 | 14 | 10 | 8 |
| QAS(1) | 0.5 | 0.8 | 0.4 | 1.0 | 1.2 | 0.5 | 0.6 | 0.8 |
| Carbonate | 10 | 15 | 12 | 8 | 10 | 12 | 11 | 15 |
| Silicate | 3 | 5 | 4 | 6 | 5 | 4 | 3 | 2.5 |
| Citric Acid | 1 | 2 | 1.5 | 1.2 | 2 | 0.8 | 1 | 1.5 |
| STPP | 15 | 20 | 18 | 25 | 20 | 16 | 15 | 22 |
| Zeolite A | 1.5 | 1 | 2 | 0.5 | 1.2 | 0.8 | 1 | 1 |
| DTPA | 0.4 | | | | | 0.5 | 0.6 | |
| DTPMP | | | | | 0.6 | 0.5 | 0.5 | 0.4 |
| EDDS | 0.3 | 0.4 | 0.2 | 0.5 | | | | |
| PVI | | 0.2 | | 0.1 | | | | |
| PVP | | 0.2 | 0.1 | | | | | |
| PVNO | 0.08 | 0.1 | 0.2 | 0.1 | 0.12 | 0.05 | 0.12 | 0.18 |
| PVPVI | 0.12 | 0.05 | 0.07 | 0.11 | 0.16 | 0.1 | 0.07 | 0.1 |
| Dye fixative | | | | | 0.1 | 0.07 | | |
| EMC | 0.5 | 0.8 | | | | | 1.2 | |
| CMC | 0.5 | 0.4 | 1 | 0.3 | 0.5 | 0.6 | 0.8 | 0.5 |
| MA/AA(1) | 1.5 | 3 | 1.2 | 2 | 2.5 | 1.5 | 2 | 2 |
| QEA(1) | 0.5 | 0.4 | 0.5 | 0.8 | 0.6 | 0.45 | | |
| QEA(2) | | | | | | | 0.4 | 0.6 |
| SRP(1) | 0.1 | 0.05 | 0.15 | 0.08 | 0.12 | | | |
| SRP(2) | | 0.05 | | | | 0.1 | 0.05 | 0.14 |
| Amylase | 0.3 | 0.15 | | 0.1 | | 0.2 | 0.15 | |
| Cellulase | | | 0.2 | 0.1 | 0.4 | | 0.05 | 0.1 |
| Silicone | 0.1 | 0.05 | | 0.08 | 0.15 | 0.12 | 0.09 | 0.06 |
| antifoam | | | | | | | | |
| Perfume | 0.4 | 0.3 | 0.25 | 0.5 | 0.3 | | | 0.2 |
| Encap Perfume | | | | | | 0.4 | 0.4 | 0.2 |
| Miscellaneous | to | to | to | to | to | to | to | to |
| | 100% | 100% | 100% | 100% | 100% | 100% | 100% | 100% |

What is claimed is:

1. A process for preparing water-soluble pouches from at least one sheet of water-soluble film, comprising the step of shaping pouches from said water-soluble film in a series of molds, wherein said molds are positioned in an interlocking manner.

2. A process according to claim 1, whereby said molds have at least one straight edge.

3. A process according to claim 2, whereby the edges of adjoining molds are substantially parallel.

4. A process according to claim 1 whereby said molds comprise less than two corners having an internal angle of 90°.

5. A process according to claim 1, whereby said molds comprise at least one corner having an internal angle greater than 90°.

6. A process according to claim 1 whereby said molds comprise at least 5 corners.

7. A process according to claim 1 whereby the shape of said molds is a polygon.

8. A process according to claim 7, whereby the shape of said molds is a hexagon.

9. A process according to claim 1 whereby said water-soluble pouch contains a detergent composition.

10. A process according to claim 1 whereby said water-soluble film comprises polyvinyl alcohol.

11. A process according to claim 1 wherein the maximum variation in the distance between adjoining molds is less than 200%.

12. A water-soluble pouch, obtainable by the process of claim 8.

13. A mold, or series of molds, for a water-soluble pouch, wherein the shape of said mold, is a hexagon.
